(19) United States
(12) Patent Application Publication
(10) Pub. No.: US 2023/0311214 A1
(43) Pub. Date: Oct. 5, 2023

(54) EXTERNALLY MOUNTED FLANGE FACING SYSTEM

(71) Applicant: Team Industrial Services, Inc., Sugar Land, TX (US)

(72) Inventors: Mark KING, Cumbria (GB); Jimi WADE, Cumbria (GB); Mark COLQUITT, Sugar Land, TX (US)

(21) Appl. No.: 18/024,882

(22) PCT Filed: Sep. 19, 2021
(86) PCT No.: PCT/US2021/051006

§ 371 Date: Mar. 6, 2023

Related U.S. Application Data
(60) Provisional application No. 63/083,365, filed on Sep. 25, 2020.

(51) Int. Cl. B23B 3/26

(52) U.S. Cl. CPC B23B 3/265; B23B 2270/08; B23B 2270/22

(57) ABSTRACT

A technique facilitates performance of a machining operation on a component, e.g. a flange. An embodiment of the technique may employ an externally mounted flange facing machine having an external housing with a hollow interior therethrough. The externally mounted flange facing machine may further comprise a plurality of clamping feet mounted to the external housing and oriented for external engagement with the flange. A surface facing arm assembly may be movably mounted to the external housing for rotation in the hollow interior. Additionally, a tool carrier assembly may be movably mounted to the surface facing arm assembly. A feed assembly may be coupled with the tool carrier assembly to drive the tool carrier assembly linearly along the surface facing arm assembly as the surface facing arm assembly rotates in the hollow interior.

### CROSS-REFERENCE TO RELATED APPLICATION

The present document is based on and claims priority to U.S. Provisional Application Ser. No. 63/083,365, filed Sep. 25, 2020, which is incorporated herein by reference in its entirety.

### FIELD OF DISCLOSURE

In general, the disclosure describes a system and methodology for facing flanges. The system comprises an assembly which may be externally mounted on a flange and operated to perform the facing operation with both rotary and linear motion.

### BACKGROUND OF DISCLOSURE

Various tubing and other structural components of industrial systems are coupled together by flanges. Periodically, it may be necessary to perform machining operations on certain flanges to properly surface, repair, or improve the flanges. For example, the machining operations may comprise re-facing of the flanges. Various types of equipment are available for performing such machining operations. However, existing equipment tends to involve substantial operator interaction with the equipment to achieve desired results and this manual interaction can result in risk to the operator.

What is needed is an improved flange facing system and methodology which reduces the operator interaction with the system.

### SUMMARY

This summary is provided to introduce a selection of concepts that are further described below in the detailed description. However, many modifications are possible without materially departing from the teachings of this disclosure. Accordingly, such modifications are intended to be included within the scope of this disclosure as defined in the claims. This summary is not intended to identify key or essential features of the claimed subject matter, nor is it intended to be used as an aid in limiting the scope of the claimed subject matter.

According to an embodiment, a system and methodology are provided for performing a machining operation on a component, e.g. a facing operation on a flange. The technique may employ an externally mounted flange facing machine having an external housing with a hollow interior therethrough. The externally mounted flange facing machine may further comprise a plurality of clamping feet mounted to the external housing and oriented for external engagement with the flange. A surface facing arm assembly may be movably mounted to the external housing for rotation in the hollow interior. Additionally, a tool carrier assembly may be movably mounted to the surface facing arm assembly. A feed assembly may be coupled with the tool carrier assembly to drive the tool carrier assembly linearly along the surface facing arm assembly as the surface facing arm assembly rotates in the hollow interior.

### BRIEF DESCRIPTION OF THE FIGURES

Certain embodiments of the disclosure will hereafter be described with reference to the accompanying drawings, wherein like reference numerals denote like elements. It is emphasized that, in accordance with standard practice in the industry, various features are not drawn to scale. In fact, the dimensions of various features may be arbitrarily increased or reduced for clarity of discussion. It should be understood, however, that the accompanying figures illustrate the various implementations described herein and are not meant to limit the scope of various technologies described herein, and:

FIG. 1 is an orthogonal view of an example of an externally mounted flange facing machine in accordance with embodiments of the present disclosure;

FIG. 2 is an orthogonal view of an example of an externally mounted flange facing machine in accordance with embodiments of the present disclosure;

FIG. 3 is a cross-sectional view of the externally mounted flange facing machine illustrated in FIG. 2 in accordance with embodiments of the present disclosure;

FIG. 4 is a top view of an example of an externally mounted flange facing machine in accordance with embodiments of the present disclosure;

FIG. 5 is a top view of the externally mounted flange facing machine illustrated in FIG. 4 but in a different operational position in accordance with embodiments of the present disclosure; and

FIG. 6 is an illustration of an example of a tool carrier assembly which can be adjusted to different angular orientations in accordance with embodiments of the present disclosure.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements.

The present disclosure generally relates to a system and methodology for performing a machining operation on a component, e.g. a facing operation on a flange. The technique may employ an externally mounted flange facing machine that can be mounted onto existing or new site equipment to perform various machining tasks while remaining stationary. According to an embodiment, the externally mounted flange facing machine may comprise an external housing with a hollow interior therethrough and a plurality of clamping feet mounted to the external housing. The clamping feet are oriented for external engagement with the flange. A surface facing arm assembly may be movably mounted to the external housing for rotation in the hollow interior. Additionally, a tool carrier assembly may be movably mounted to the surface facing arm assembly for performance of desired machining tasks. In this embodiment, a feed assembly may be coupled with the tool carrier assembly to drive the tool carrier assembly linearly along the surface facing arm assembly as the surface facing arm assembly rotates in the hollow interior.

According to an example, the surface facing arm assembly and tool carrier assembly may be mechanically driven by a primary drive motor which transmits torque to the rotating surface facing arm assembly. To linearly, e.g. linearly in a radial direction, feed the tool carrier assembly across the face of the flange, an automatic mechanical feed system may be employed. As the surface facing arm assembly rotates, it automatically transmits linear movement to the tool carrier assembly along the surface facing arm assembly. This negates the need for an operator to interact with the machine during a machining operation, e.g. a flange facing operation. Various mechanisms may be used for feeding the tool carrier assembly in the desired direction or directions. In some embodiments, the same automatic mechanical feed system may be constructed to provide tool movement in both a radial and axial direction during a machine operation. The automatic mechanical feed system can be designed to allow an operator to alternate between axial and radial feed of the tool carrier assembly as desired.

The externally mounted flange facing machine may be constructed as a lightweight and portable machine. When existing or new site equipment is to be machined, the externally mounted flange facing machine may be located around the component so the machining operation may be performed at that location. The clamping feet may be individually actuated and arranged circumferentially to facilitate external mounting of the flange facing machine around the component to be machined. Adjustable features also may be employed to aid an operator in setting the flange facing machine in an axial direction. Once the externally mounted flange facing machine is secured on the desired component, the machine remains stationary while the surface facing arm assembly is rotated to enable the tool carrier assembly and corresponding tool to perform the desired machining operations. The ability to feed the tool carrier assembly in a plurality of directions, e.g. along a plurality of axes, reduces operator interaction with the flange facing machine.

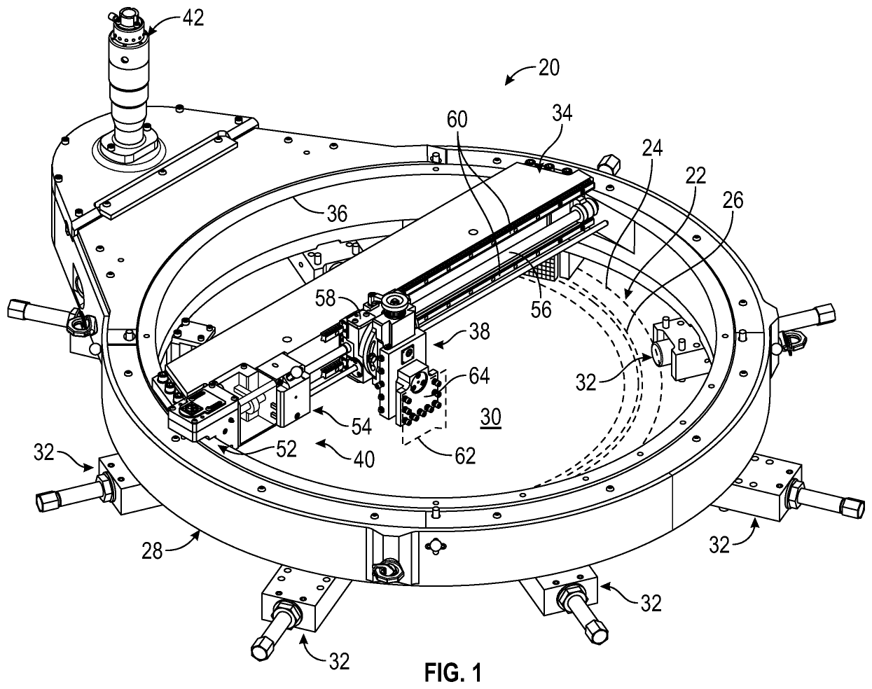

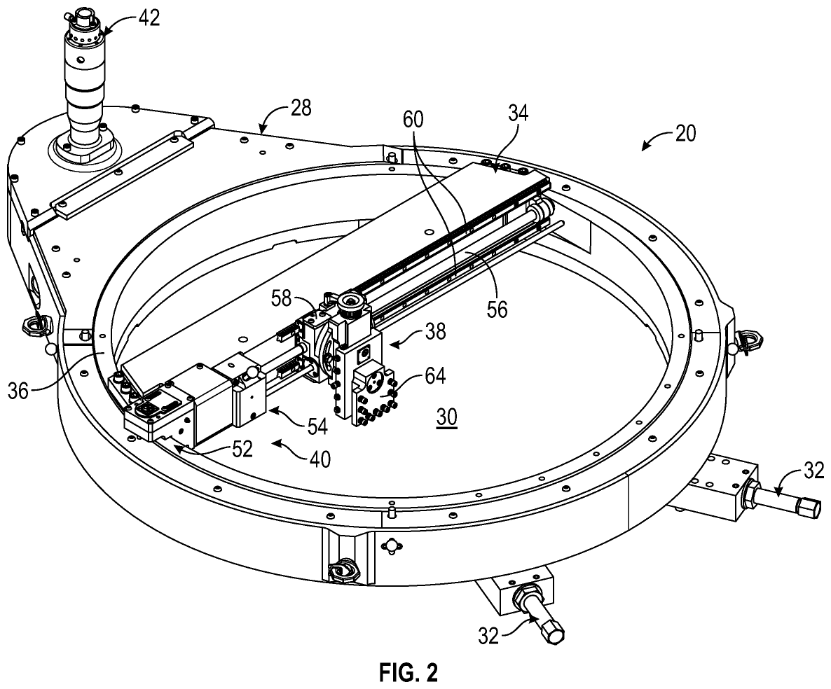

Referring generally to FIGS. 1 and 2, an embodiment of an externally mounted flange facing machine 20 is illustrated as mounted externally onto a component 22 having a flange 24, e.g. a circular flange, with a flange face 26 to be machined. In this example, the flange facing machine 20 comprises an external housing 28 having a hollow interior 30 therethrough. In the illustrated embodiment, external housing 28 is generally circular in shape. The flange facing machine 20 also may comprise a plurality of clamping mechanisms 32, e.g. clamping feet 32, mounted to the external housing 28. The clamping feet 32 are oriented for external engagement with the flange 24 or other suitable component. At least some of the clamping feet 32 may be adjustable in a radial direction and, in some embodiments, at least some of the clamping feet 32 may be adjustable in an axial direction. As illustrated, the clamping feet 32 may be mounted in a circumferential pattern about the external housing 28 and oriented inwardly toward the flange 24.

As further illustrated, the flange facing machine 20 may comprise a surface facing arm assembly 34 movably mounted to the external housing 28 for rotation in the hollow interior 30. In some embodiments, the surface facing arm assembly 34 may comprise or may be coupled with a rotatable ring 36 rotatably mounted to the external housing 28 to enable the rotational motion. For example, the rotatable ring 36 may be rotatably mounted within the hollow interior 30 of external housing 28. A tool carrier assembly 38 may be movably mounted to the surface facing arm assembly 34 for linear movement along the surface facing arm assembly 34 in, for example, a radial direction. Thus, both rotational and linear motion may be imparted to the tool carrier assembly 38. According to an embodiment, a feed assembly 40 may be coupled with the tool carrier assembly 38 to drive the tool carrier assembly 38 linearly along the surface facing arm assembly 34 as the surface facing arm assembly 34 rotates in hollow interior 30.

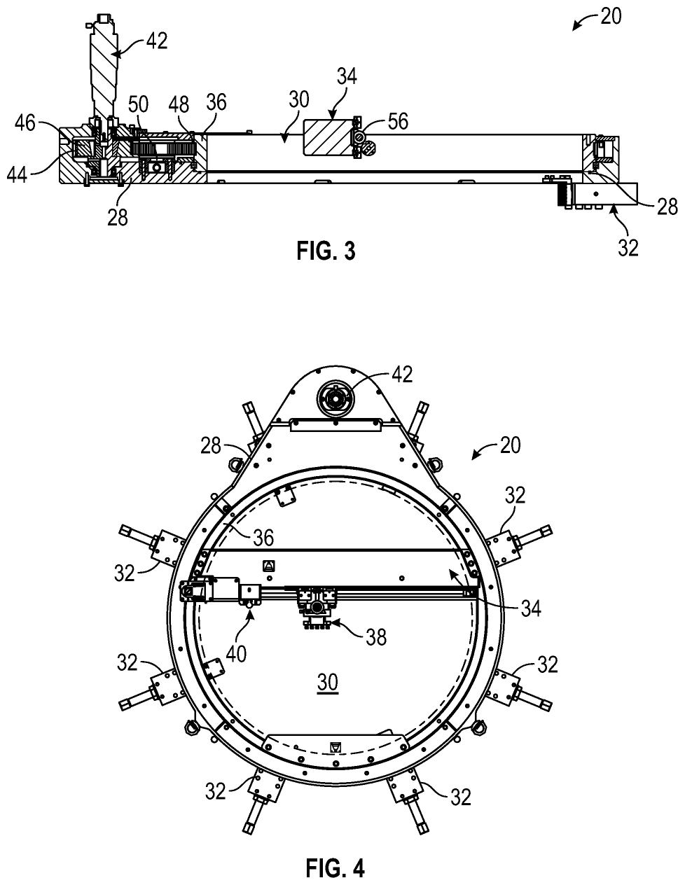

According to the illustrated example, the externally mounted flange facing machine 20 further comprises a primary drive motor 42 which may be mounted to an extended portion of external housing 28. The illustrated primary drive motor 42 is a pneumatic motor, however other types of drive motors 42 may be utilized, such as electric motors, hydraulic motors, or other suitable drivers. With additional reference to FIG. 3, the primary drive motor 42 may be operatively coupled with rotatable ring 36 via a belt 44 or other suitable drive mechanism. In the illustrated example, belt 44 is connected to motor 42 via a drive pulley 46 and to rotatable ring 36 via a belt drive ring region 48. A tensioner 50 may be used to maintain proper tension of belt 44.

Operation of primary drive motor 42 causes rotation of rotatable ring 36 and thus rotation of the surface facing arm assembly 34 about the hollow interior 30. The rotational movement may be used to impart linear movement of tool carrier assembly 38 via feed assembly 40. The feed assembly 40 may have a variety of configurations selected to impart the desired linear motion of the tool carrier assembly 38 along the surface facing arm assembly 34. According to an embodiment, the feed assembly 40 may comprise a feed gearbox assembly 52 which converts the rotational motion of rotatable ring 36 to the desired linear motion of tool carrier assembly 38. For example, the feed gearbox assembly 52 may be driven via engagement of a roller or gear with the external housing 28 as ring 36 is rotated. In the illustrated example, the feed gearbox assembly 52 operates in cooperation with a feed selector gearbox assembly 54 to impart a desired linear feed and feed rate with respect to tool carrier assembly 38.

In some embodiments, the feed gearbox assembly 52 and feed selector gearbox assembly 54 may be used to impart rotational movement to a feed rod 56 which is rotated through a corresponding gearbox 58 of tool carrier assembly 38. The feed rod 56 may be threaded with a desired thread pitch to cause linear movement of tool carrier assembly 38 along a corresponding rail or rails 60 of surface facing arm assembly 34. Thus, as drive motor 42 is operated to impart rotational movement to the surface facing arm assembly 34, a desired linear motion is imparted to the tool carrier assembly 38 via feed assembly 40.

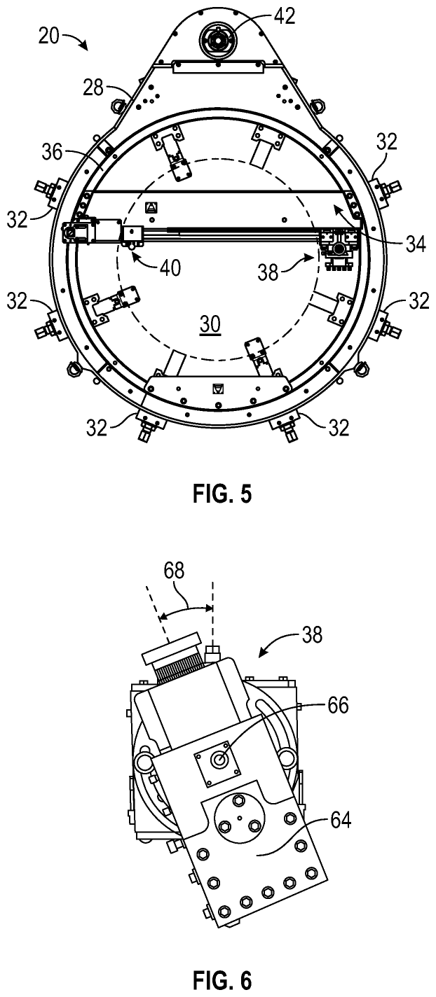

As a result of this imparted linear motion, the tool carrier assembly 38 is automatically adjusted along surface facing arm assembly 34 between, for example, a first position, as illustrated in FIG. 4, and a second position illustrated in FIG. 5. The rate and distance of the linear feed, e.g. a radially oriented linear feed, may be selected and/or adjusted according to the parameters of a given machining operation. Thus, the tool carrier assembly 38 may be moved in a plurality of directions, e.g. along a plurality of axes, without additional interaction from an operator. It should be noted, FIGS. 4 and 5 also illustrate adjustment of the clamping feet 32 to different radial positions represented by the dashed lines showing a larger (FIG. 4) and smaller (FIG. 5) radius of adjustment.

It should be noted the tool carrier assembly 38 may be constructed for cooperation with a variety of machining tools 62. An example of a machining tool 62 is a facing tool used for facing a metal flange 24. In some embodiments, the tool carrier assembly 38 may include a power downfeed tool post assembly 64 which may be used to adjust the axial position of the attached machining tool 62. For example, the axial position of the machining tool 62 may be adjusted to achieve a shallower or deeper depth of cut on face 26 of flange 24. For some operations, the tool post assembly 64 also may be angularly adjustable about an adjustment axis 66 to enable positioning of the machining tool 62 at different angular positions represented by angle 68 in FIG. 6.

In an operational example, the portable flange facing machine 20 may be mounted to flange 24, via clamping feet 32, to perform a flange facing operation. The axial position of the machining tool 62 is then adjusted (or the downfeed of the power downfeed tool post assembly 64 is adjusted) to control the depth of cut. The drive motor 42 is operated to rotate ring 36 and thus surface facing arm assembly 34 to move the tool carrier assembly 38 and cutting tool 62 in a circular direction. Simultaneously, the tool carrier assembly 38 and cutting tool 62 are automatically driven in a linear radial direction along the surface facing arm assembly 34 via, for example, feed assembly 40, feed rod 56, and gearbox 58. As a result, the facing of flange 24 is achieved by simultaneous cutting in a circular direction and a linear radial direction. As discussed above, some embodiments may utilize a powered downfeed tool post assembly 64 to also feed the cutting tool 62 in an axial or depth direction.

Depending on the parameters of a facing or other machining operation, the size and configuration of the externally mounted flange facing machine 20 may be adjusted. For example, the flange facing machine 20 may be constructed with housing 28 in different sizes and configurations. Similarly, the primary drive motor 42 may be utilized with a variety of mechanical mechanisms to impart the desired rotational motion. Various types of feed assemblies 40 also may be powered by drive motor 42 or by an independent driving device through various gearboxes or other motion conversion mechanisms to impart the desired linear motion. Furthermore, the tool carrier assembly 38 may be constructed to accommodate various types of tools and tool adjustments to accomplish a desired machining operation.

Although a few embodiments of the disclosure have been described in detail above, those of ordinary skill in the art will readily appreciate that many modifications are possible without materially departing from the teachings of this disclosure. For example, the pipe isolation device of the present disclosure may be modified by adding additional sealing heads to become a triple, or more, block and bleed apparatus. Accordingly, such modifications are intended to be included within the scope of this disclosure as defined in the claims. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

What is claimed is:

1. A system for facing a flange, comprising:
an externally mounted flange facing machine having:
an external housing having a hollow interior therethrough;
a plurality of clamping feet mounted to the external housing and oriented for external engagement with the flange;
a surface facing arm assembly movably mounted to the external housing for rotation in the hollow interior;
a tool carrier assembly movably mounted to the surface facing arm assembly; and
a feed assembly coupled with the tool carrier assembly to drive the tool carrier assembly linearly along the surface facing arm assembly as the surface facing arm assembly rotates in the hollow interior.

2. The system as recited in claim 1, wherein the externally mounted flange facing machine further comprises a primary drive motor coupled with the surface facing arm assembly to rotate the surface facing arm assembly in the hollow interior.

3. The system as recited in claim 2, wherein the primary drive motor is a pneumatic motor.

4. The system as recited in claim 1, wherein clamping feet of the plurality of clamping feet may be adjusted in a radial direction to clamp onto the flange.

5. The system as recited in claim 1, wherein clamping feet of the plurality of clamping feet are distributed circumferentially about the external housing.

6. The system as recited in claim 1, wherein the tool carrier assembly comprises a gearbox.

7. The system as recited in claim 6, wherein the gearbox is driven via a threaded feed rod.

8. The system as recited in claim 7, wherein the feed rod is rotated by a feed gearbox assembly mounted into the surface facing arm assembly.

9. The system as recited in claim 1, wherein the surface facing arm assembly is mounted on a rotatable ring which is rotatably secured in the external housing.

10. A system, comprising:
a portable machine mountable to a component for performing a cutting operation on the component, the portable machine comprising:
a housing;
a plurality of clamping mechanisms coupled to the housing and oriented to releasably secure the portable machine to an exterior of the component;
an arm assembly mounted to the housing for rotation with respect to the housing;
a tool carrier assembly movably mounted to the arm assembly; and
a feed assembly coupled with the tool carrier assembly to drive the tool carrier assembly linearly along the arm assembly as the arm assembly rotates with respect to the housing.

11. The system as recited in claim 10, wherein the housing has a hollow interior, the arm assembly rotating about the hollow interior.

12. The system as recited in claim 11, further comprising a cutting tool mounted to the tool carrier assembly.

13. The system as recited in claim 11, wherein the portable machine further comprises a motor connected to the arm assembly in a manner enabling rotation of the arm assembly during the cutting operation.

14. The system as recited in claim 13, wherein the motor also powers the feed assembly to drive the tool carrier assembly linearly.

15. The system as recited in claim 10, wherein the clamping mechanisms of the plurality of clamping mechanisms are radially adjustable and oriented to clamp onto a circular flange of the component.

16. The system as recited in claim 14, wherein the tool carrier assembly comprises a gearbox which is driven via a threaded feed rod.

17. A method, comprising:
removably mounting a flange facing machine to a flange of a component;
using a surface facing arm assembly of the flange facing machine to position a cutting tool into engagement with a flange face of the flange;
rotating the surface facing arm assembly to move the cutting tool in a circular motion along the flange face; and
automatically shifting the cutting tool in a radial direction along the surface facing arm assembly while rotating the surface facing arm assembly.

18. The method as recited in claim 17, wherein removably mounting comprises using a plurality of clamping feet to clamp the flange facing machine to the flange.

19. The method as recited in claim 17, wherein rotating comprises rotating the surface facing arm assembly along an external housing, of the flange facing machine, via a motor mounted to the external housing.

20. The method as recited in claim 17, wherein automatically shifting comprises using a gearbox mounted along a threaded feed rod to move the cutting tool in the radial direction.
